(19) United States
(12) Patent Application Publication
(10) Pub. No.: US 2011/0001635 A1
(43) Pub. Date: Jan. 6, 2011

(54) MOBILE TRAFFIC MONITORING SYSTEM

(75) Inventors: Jody H. Akens, Weston, FL (US); Scott A. Fudally, Coral Springs, FL (US); Ali H. Zaidi, Weston, FL (US)

Correspondence Address: MOTOROLA, INC.;Penny Tomko, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/937,543

(22) Filed: Nov. 9, 2007

(51) Int. Cl. G08G 1/052; G08G 1/01; G08G 1/04

(52) U.S. Cl. 340/936; 340/933; 340/937

(57) ABSTRACT

A method (400) and a system (125) for monitoring traffic. A warning zone (130) can be defined based, at least in part, on a present location of a mobile traffic monitoring system (125). With the mobile traffic monitoring system, the warning zone can be optically monitored for movement of an object (175). Responsive to identifying the movement of the object in the warning zone, an alert (135) can be generated.

### BACKGROUND OF THE INVENTION

1. Field of the Invention

The present invention generally relates to highway safety systems and, more particularly, to traffic monitoring systems.

2. Background of the Invention

Law enforcement and emergency responders at incident scenes where there is heavy vehicle traffic are often vulnerable to injuries, which sometimes are fatal, caused by reckless motorists. For example, in the state of Florida for a five year period between 1996 and 2000, nearly two thousand accidents were reported involving stopped or parked law enforcement vehicles. Similar accident rates also occur for other workers performing their job duties on or near roadways (e.g. emergency responders, such as fire fighters and emergency medical technicians, tow truck operators, and road construction and maintenance personnel).

Since the attention of these workers is typically focused on performing their job duties, remaining alert for careless or drunken drivers who threaten their safety is difficult. Although at least twenty seven states have implemented move over laws, which require motorists to change lanes or reduce speeds as they approach emergency workers or traffic stops, public awareness of these laws is limited, as is public compliance. Also, the speed at which oncoming traffic oftentimes approaches provides little response time for a worker to react to a potentially dangerous situation.

For example, if a highway patrolman stops a vehicle that is suspected of being stolen, the officer must remain focused on occupants within the vehicle as he approaches the vehicle to monitor for suspect activity. Meanwhile, traffic may be moving past the officer at high speeds. With his attention focused on the vehicle and its occupants, the officer may not have an awareness of a wayward vehicle traveling toward him, and thus may not have adequate time to avoid being struck by such a vehicle.

### SUMMARY OF THE INVENTION

The present invention relates to a method of monitoring traffic. The method can include defining a warning zone based, at least in part, on a present location of a mobile traffic monitoring system. With the mobile traffic monitoring system, the warning zone can be optically monitored for movement of an object. Responsive to identifying the movement of the object in the warning zone, a first alert can be generated.

The present invention also relates to a mobile traffic monitoring system. The system can include a controller that defines a warning zone based, at least in part, on a present location of the mobile traffic monitoring system. The system can also include an optical monitor that optically monitors the warning zone for movement of an object. Responsive to the optical monitor identifying the movement of the object in the warning zone, the controller can generate a first alert.

The present invention also relates to a program storage device readable by a machine, tangibly embodying a program of instructions executable by the machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a view of a traffic scene that is useful for understanding the present invention;

FIG. 2 depicts a block diagram of a mobile traffic monitoring system that is useful for understanding the present invention;

FIG. 3 depicts a communications system that is useful for understanding the present invention; and

FIG. 4 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for monitoring traffic to identify potentially dangerous conditions. The system can define a warning zone and optically monitor the warning zone for a movement of an object. If the movement of the object within the warning zone is identified, the system can then generate an alert, for example to indicate a potentially unsafe condition. The term warning zone as used herein refers to an exclusionary area, the intrusion into which by an object or person may potentially threaten the safety of a protected resource.

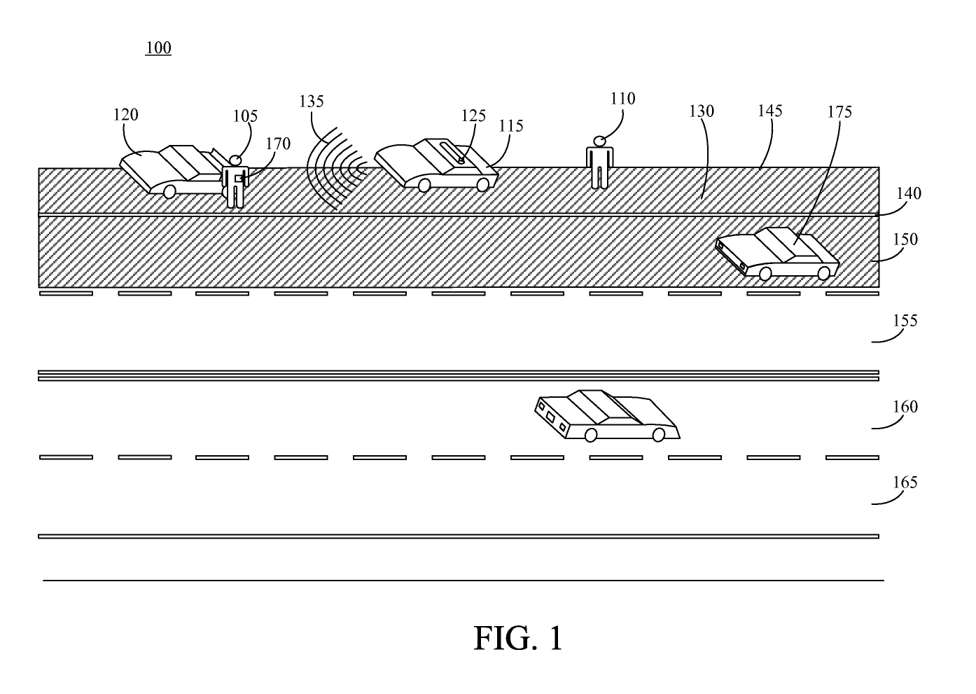

FIG. 1 depicts a view of a traffic scene 100 that is useful for understanding the present invention. One or more protected resources, for instance one or more individuals 105, 110 and/or one or more vehicles 115, 120 may be present at the traffic scene 100. The individuals 105, 110 can be law enforcement officers, motor vehicle operators, emergency responders, tow truck operators, construction and maintenance workers, or any other individuals that may be in danger of being injured by traffic at the traffic scene 100. Similarly, the vehicles 115, 120 can be any vehicles that may be present at the traffic scene 100, for instance vehicles operated by, or otherwise associated with, the individual 105 and/or the individual 110. The vehicle 120 also may be a vehicle that has been stopped by a law enforcement officer or one that requires assistance. Although these representations will be used throughout the description for FIG. 1, it will be appreciated by one skilled in the art that the protected resources are not limited to the individuals 105, 110 and the vehicles 115, 120, but can represent any of a variety of protected resources (e.g. tools, structures, construction equipment, etc.).

The vehicle 115 can include a mobile traffic monitoring system 125. The mobile traffic monitoring system 125 can define a warning zone 130 based, at least in part, on a present location of the mobile traffic monitoring system 125. Further, the mobile traffic monitoring system 125 can optically monitor the protected resources 105-120 and objects within the warning zone 130. For example, the mobile traffic monitoring system 125 can receive and process image data to identify objects and/or persons entering into and/or moving in the warning zone, or otherwise presenting a potential danger to the protected resources 105-120. When such a condition is detected, the mobile traffic monitoring system 125 can generate one or more of an alert(s) 135 to one or more of the individuals 105, 110.

To define the warning zone 130, the mobile traffic monitoring system 125 can receive image data collected from the present location of the mobile traffic monitoring system 125. The mobile traffic monitoring system 125 can process the image data to identify landscape features, such as a lane marker 140, which can be used to determine a present location and/or orientation of the mobile traffic monitoring system 125 relative to the traffic scene 100. The warning zone 130 then may be defined based on a set of parameters (e.g. length, width and/or shape) established by the traffic monitoring system 125. For example, the mobile traffic monitoring system 125 can establish the warning zone 130 to extend a particular distance beyond one or both sides of the lane marker 140 and/or a portion of the road 145 (e.g. shoulder of the road), and to extend a particular distance behind and/or in front of the vehicle 115. Further, the warning zone 130 can also be defined to extend across one or more lanes of traffic 150, 155, 160, 165. Indeed, the warning zone 130 can be defined to cover all lanes of traffic 150-165, though this need not be the case.

A user of the mobile traffic monitoring system 125, for instance the individual 105, can review the proposed warning zone 130 created by the mobile traffic monitoring system 125 and, if the user desires, modify the warning zone parameters. For instance, the user can modify the warning zone parameters by entering one or more user inputs into a user interface of the mobile traffic monitoring system 125. As an example, if traffic moves at an especially high speed past the traffic scene 100, the user may extend the distance that the warning zone 130 extends behind and/or in front of the vehicle 115, thereby providing for earlier detection of vehicles entering the warning zone 130, and thus a greater amount of time for the protected resources, such as the individual 105 and/or individual 110, to respond to one or more of the alert(s) 135.

With the warning zone 130 established, the mobile traffic monitoring system 125 can capture and store successive image data of the traffic scene 100. The mobile traffic monitoring system 125 can process the image data to track protected resources 105-120 within the warning zone 130.

In addition to image data, the mobile traffic monitoring system 125 can also monitor position information correlating to the protected resources, such as the individual 105 and the vehicle 115. The position information can be received from, for example, one or more global positioning systems (GPSs) or local positioning systems. Such positioning systems are known to the skilled artisan and can be included in the mobile traffic monitoring system 125 or the vehicle 115, as well as a communication device 170 associated with one or more of one or more protected resource(s). The position information can be processed in addition to, or in lieu of, the image data to track the movement and relative position of the individual 105 and/or the vehicle 115, for example relative to the warning zone 130. In one arrangement, the mobile traffic monitoring system can generate a warning zone alert(s) each time the individual 105 moves out of the warning zone 130.

The mobile traffic monitoring system 125 can also track the position of other objects, for example a vehicle 175 or another individual 110, moving into or near the warning zone 130. The mobile traffic monitoring system 125 can track such objects using the image data captured at the traffic scene 100, one or more radar detectors, one or more laser detectors, and/or using any other suitable tracking tools. If the mobile traffic monitoring system 125 determines that the position of the vehicle 175 is located within the warning zone 130, the mobile traffic monitoring system 125 can generate the warning zone alert.

In one arrangement, the mobile traffic monitoring system 125 can also determine movement parameters (e.g. speed or velocity) for the vehicle 175, for example with respect to the position and movement of the protected resources 105-120. If the mobile traffic monitoring system 125 determines that a collision between the vehicle 175 and a protected resource 105-120 is likely (e.g. a probability of colliding is at least equal to a threshold value), the mobile traffic monitoring system 125 can generate a collision warning alert(s) to indicate an impending collision.

The mobile traffic monitoring system 125 can also determine whether a collision has occurred between the vehicle 175 and a protected resource 105-120. For example, if the image data reveals a rapid change of position for the individual 105, or the mobile traffic monitoring system 125 loses a communication link to the communication device 170, the mobile traffic monitoring system can determine a collision has occurred between the vehicle 175 and the individual 105. In response to such determination, the mobile traffic monitoring system 125 can generate a collision alert(s) to indicate a collision has occurred.

The mobile traffic monitoring system 125 can generate one or more of the alert(s) 135 via any number of modalities. For example, the alert 135 can be communicated as an acoustic signal and/or a visual signal. If the alert is an acoustic signal, the volume, frequency and/or modulation of the alert(s) 135 can be selected to indicate a particular type of warning. The mobile traffic monitoring system 125 may also transmit the alert(s) 135 to a communication device 170 as an RF signal. In such an arrangement, the alert(s) 135 may also include text, audio, image, position and/or time information which may be processed by the communications device 170. In response to the alert(s) 135, the communication device 170 can generate an audible, visible and/or haptic signal detectable by the individual 105.

The mobile traffic monitoring system 125 can also transmit one or more of the alert(s) 135 to a communications server as an RF signal. In response to the alert(s) 135, the communications server can implement suitable alert processing functions. For example, the communications server can contact one or more emergency responders. The alert(s) 135 also may include text, audio, image, position and/or time information which may be processed by the communications server.

Various traffic information functions can also be provided by the mobile traffic monitoring system 125. For example, the mobile traffic monitoring system 125 can monitor for traffic violations. The mobile traffic monitoring system 125 can store information related to such traffic violations and/or transmit such information to the communications server. For example, if the mobile traffic monitoring system 125 detects the vehicle 175 committing a speeding violation, the mobile traffic monitoring system 125 can store an image of the tag of the vehicle 175 and transmit the tag and violation information to the communications server (e.g. highway patrol station). Descriptive information, such as a time, location, and nature of the violation can also be stored and/or communicated to the communications server.

The mobile traffic monitoring system 125 can also monitor local traffic and provide traffic information. Such information may include, for example, current and past traffic accidents, traffic anomalies (e.g. heavy traffic flows in construction areas), other traffic stops in a region, etc. Further, information related to the location of other first responders in relation to the mobile traffic monitoring system 125 can also be monitored and communicated to the protected resources. As an example, a patrolman at an accident site can monitor the progress of an ambulance as it approaches the accident scene.

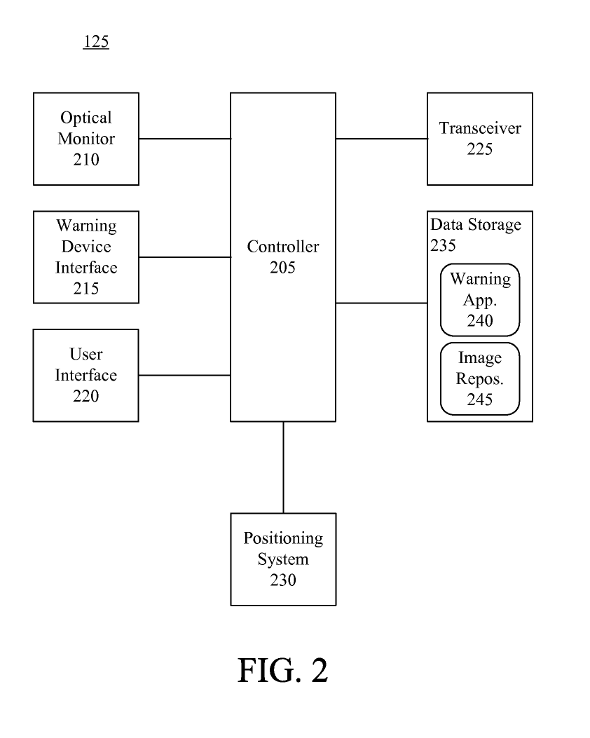

FIG. 2 depicts a block diagram of the mobile traffic monitoring system 125 that is useful for understanding the present invention. The mobile traffic monitoring system 125 can include a controller 205, which can be any suitable processing system or group of processing systems. For example, the controller 205 can comprise one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The mobile traffic monitoring system 125 can include an optical monitor 210 that captures images and generates image data. For example, the optical monitor 210 can detect light generated by or scattered off of an individual and/or an object. Such light can be in the infra-red spectrum, the visible spectrum, the ultra-violate spectrum and/or any other light spectrum that can be detected. The optical monitor 210 can comprise an image sensor, for instance a charge coupled device (CCD), a complementary metal oxide semiconductor (CMOS) active pixel sensor and/or any other suitable image sensor(s). Such image sensors are known to the skilled artisan.

The traffic monitoring system 125 can also include a warning device interface 215. The warning device interface 215 can communicate alerts to activate one or more warning devices, for example, a siren, a horn, a light bar, head lights, indicator lamps, or any other suitable warning device. Further, the warning device interface 215 can modulate or otherwise vary such signals to achieve a desired warning signal from one or more of the warning devices.

A user interface 220 can also be provided with the mobile traffic monitoring system 125. The user interface 220 can comprise, for example, one or more displays, keys, buttons, indicator lamps, audio output transducers (e.g. loudspeakers), audio input transducers (e.g. microphones), sensors, haptic output devices, and the like. In one arrangement, the user interface 220 can include a touch screen display, which may receive user inputs via a stylus and/or user appendage.

The traffic monitoring system 125 can also include a transceiver 225, which can send and receive wireless communications according to any of a variety of communication standards and/or protocols. For example, the transceiver 225 can be suitably configured to communicate via a communications network, which will be described herein, or directly with one or more communication devices.

The mobile traffic monitoring system 125 further can include a positioning system 230. The positioning system 230 can be a global positioning system, for example a GPS, a local positioning system, a beacon, a transponder, an RFID tag or any other system or device that can indicate a location of the traffic monitoring system 125.

A data storage 235 can also be provided. The data storage 235 can include one or more storage devices, each of which may include, but is not limited to, a magnetic storage medium, an electronic storage medium, an optical storage medium, a magneto-optical storage medium, and/or any other storage medium suitable for storing digital information. In one arrangement, the data storage 235 can be integrated into the controller 205, though this need not be the case.

A warning application 240 can be stored on the data storage. The warning application 240 can be executed by the controller 205 to implement the methods and processes described herein. For example, the controller 205 can execute the warning application 240 to identify a present location of the mobile traffic monitoring system 125 and define a warning zone based, at least in part, on such location. The present location can be identified based on image data received from the optical monitor 210 (e.g. representing lane lines, road material, road signs, etc.) and/or position information received from the positioning system 230. Position information for protected resources can also be processed to define the warning zone.

Via the user interface 220, the controller 205 can present the defined warning zone as a proposed warning zone, and solicit user inputs to further define the warning zone by modifying the proposed warning zone. For example, an image of the present location can be presented with an overlay that depicts the proposed warning zone. An individual can be prompted to enter user inputs to change the size and/or shape of the warning zone with respect to the present location and/or with respect to one or more objects at the present location.

The controller 205 can also execute the warning application 240 to control the optical monitor 210 and processes image data captured by the optical monitor 210. The controller 205 can process such image data to monitor positions and movement of protected resources, detect movement of individuals and/or objects (e.g. vehicles) within the warning zone, determine movement parameters of such individuals/objects (e.g. speed or velocity), and determine whether any individuals/objects pose a potential danger to a protected resource, as previously described. Movement parameters can be determined in any suitable manner. For example, an amount of movement of an object between two successive images can be determined, as well as the amount of time lapsed between the successive images. The speed and/or velocity of the object can be determined based on the movement and lapsed time. In addition, the controller 205 can also determine a level of probability of a collision between an object and a protected resource, and determine whether a collision has occurred.

In addition to, or in lieu of, image data, the controller 205 can process position information associated with the protected resources to monitor their respective positions and movements. For instance, via the transceiver 225 the controller 205 can receive position information transmitted by positioning systems associated with the protected resources. As noted, such a positioning system can be a global positioning system, local positioning system, or RFID of a communication device associated with a protected resource (e.g. a mobile radio carried by an individual).

One or more alerts can be generated by the controller 205 in response to detecting individuals and/or objects within the warning zone, determining individuals/objects that pose a danger to a protected resource, or detecting that a collision has occurred. Such alerts can be communicated to the warning device interface 215 to activate one or more warning devices which communicate the alerts to the protected resource(s), and/or to the transceiver 225 to communicate the alerts to a communication device associated with a protected resource and/or a server, as previously described.

Image data detected by the optical monitor 210 also may be stored on the data storage 235, for example within an image repository 245. In addition, descriptive information can be stored with the images. Such descriptive information can include, for example, time indicators that indicate times when images are captured. The descriptive information can also include location indicators that indicate locations where the images are captured, for example present locations of mobile traffic monitoring systems at the times the images are captured. Such image data and descriptive information can also be communicated to a server via the transceiver 225. As noted, in one aspect of the inventive arrangements, image data detected by the optical monitor 210 can include at least a portion of an object moving in the warning zone. For example, the image data can include a tag of a vehicle moving in the warning zone.

The controller 205 also may receive information, for example traffic information and location information for other emergency responders, from the communications network via the transceiver 225. If an anomaly that requires the attention of the protected resource is detected, an alert to the protected resource can be generated and communicated via the warning device interface 215 and/or the transceiver 225.

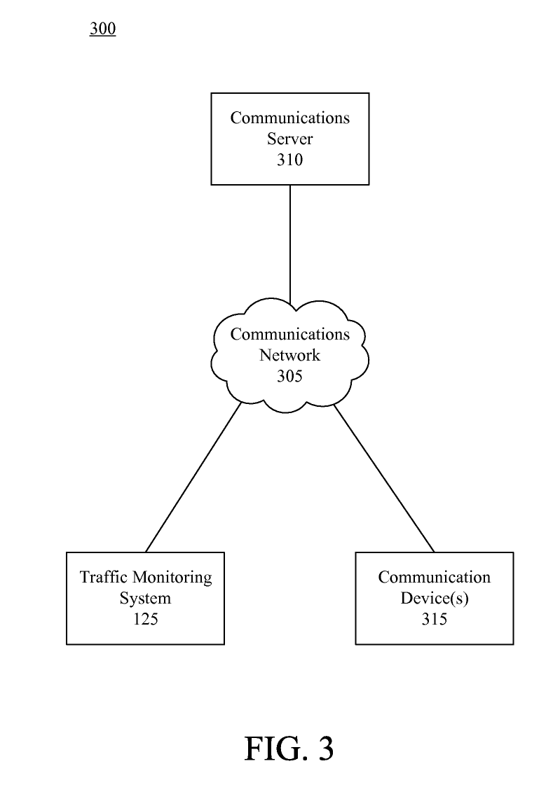

FIG. 3 depicts a block diagram of a communications system that is useful for understanding the present invention. The communications system 300 can include a communications network 305, which may comprise a wide area network (WAN), such as the Internet, the World Wide Web, a dispatch communications network, an interconnect communications network (e.g. a cellular communications network), a public switched telephone network (PSTN), and the like. The communications network also may comprise a local area network (LAN), a metropolitan area network (MAN), a WiFi network, a Mesh network, a public safety network (e.g. Astro, TETRA, HPD, etc.) and/or any other networks or systems over which communication signals can be propagated. In that regard, the communications network 305 can include wired and/or wireless communication links.

The communications network 305 can be configured to communicate data via IEEE 802 wireless communications, for example, 802.11 and 802.16 (WiMAX), 3G, 4G, EUTRAN, UMB, WPA, WPA2, GSM, TDMA, CDMA, WCDMA, OFDM, direct wireless communication, or any other communications format. Indeed, the communications network 305 can be implemented in accordance with any suitable communications standards, protocols, and/or architectures, or a suitable combination of such standards, protocols, and/or architectures.

The communications system 300 can also include a mobile traffic monitoring system 125, such as that previously described. Further, the communications system 300 optionally can include a communications server 310. The communications server 310 can be any system or device that can receive incoming messages and process such messages. For example, the communications server 310 can initiate events in response to such messages, forward such messages to other nodes of the communications system 300, or perform any other suitable communication functions. As such, the communications server 310 can comprise one or more processors/controllers, data storage devices, user interfaces, communication adapters, and/or other suitable components.

The communications system 300 optionally can include one or more communication devices 315. The communication devices 315 can include, for example, mobile telephones, mobile radios, personal digital assistants, mobile computers, or any other suitably configured wireless communication devices. As such, the communication devices can include one or more suitable processors, transceivers, data storage devices, user interfaces, and/or other suitable components. In one arrangement, one or more of the communication devices 315 can include a positioning system, such as a GPS receiver, a local positioning system or an RFID tag. The positioning systems can generate positioning data associated with the protected resources, such as emergency responders and equipment located at the incident scene.

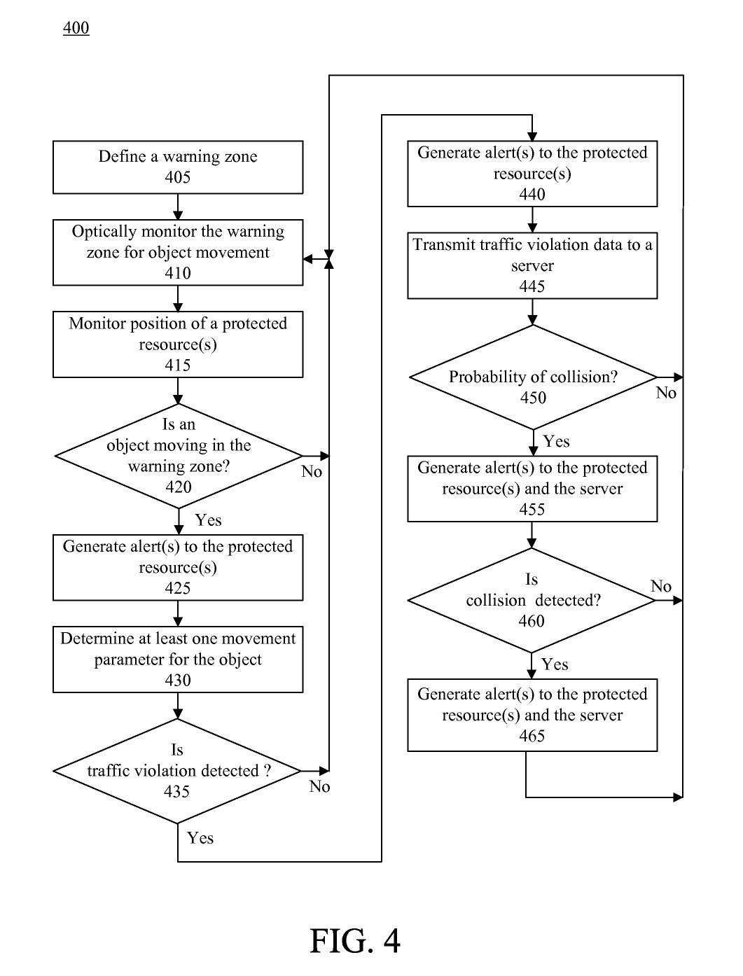

FIG. 4 is a flowchart that presents a method 400 of monitoring traffic that is useful for understanding the present invention. Beginning at step 405 a mobile traffic monitoring system can define a warning zone based, at least in part, on the present location of the mobile traffic monitoring system. The warning zone can be defined by the mobile traffic monitoring system or an individual. Further, a set of parameters determining the size and shape of the warning zone can be modified by a user through a user interface.

At step 410 the mobile traffic monitoring system can optically monitor the warning zone for object movement. It should be noted, however, that the system can monitor any area scanned by the optical monitor and is not exclusively limited to the warning zone. At step 415, the position of the protected resource(s) can be monitored, for example optically, via a global positioning system, local positioning system, RFIDs, and/or in any other suitable manner.

Referring to decision box 420, if the mobile traffic monitoring system detects an object moving within the warning zone, at step 425 an alert can be generated and communicated to one or more protected resources to indicate movement in the warning zone. At step 430, at least one movement parameter for the object can be determined. At decision box 435, if a traffic violation is not detected and there is no danger posed by the object movement, the process can return to step 410. If, however, a traffic violation has been detected and/or the object movement poses danger to a protected resource, at step 440 an alert can be generated to indicate a traffic violation and/or danger. At step 445 traffic violation data can be communicated to a server.

Proceeding to decision box 450, if there is probability of a collision between the moving object and a protected resource (e.g. a level of probability that exceeds a threshold value), at step 455 an alert can be generated to indicate a collision is likely. Such alert can be communicated to the protected resource and, optionally, the server. At decision box 460, if a collision is detected, at step 465 an alert can be generated to indicate such collision. The alert can be communicated to the protected resource and the server. Referring again to step 410, the mobile traffic monitoring system can continue to optically monitor the warning zone for object movement.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention can also be embedded in a program storage device readable by a machine, tangibly embodying a program of instructions executable by the machine to perform methods and processes described herein. The present invention can also be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of monitoring traffic comprising:
defining a warning zone based, at least in part, on a present location of the mobile traffic monitoring system;
with the mobile traffic monitoring system, optically monitoring the warning zone for movement of an object; and
responsive to identifying the movement of the object in the warning zone, generating a first alert.

2. The method of claim 1, further comprising:
communicating the first alert to a protected resource.

3. The method of claim 2, wherein communicating the first alert to the protected resource comprises communicating the first alert to a communication device associated with the protected resource.

4. The method of claim 1, further comprising:
presenting a proposed warning zone to a user;
wherein defining the warning zone comprises modifying the proposed warning zone responsive to a user input.

5. The method of claim 1, wherein monitoring the warning zone further comprises:
determining the at least one movement parameter for the object, the at least one movement parameter selected from the group consisting of a speed and a velocity.

6. The method of claim 5, further comprising:
determining whether the object has a probability of colliding with a protected resource that is at least equal to a threshold value;
responsive to determining that the probability is at least equal to the threshold value, generating a second alert; and
communicating the second alert to at least one entity selected from the group consisting of the protected resource and a server.

7. The method of claim 5, further comprising:
determining whether the object has collided with a protected resource;
responsive to determining that the object has collided with the protected resource, generating a second alert; and
communicating the second alert to the server.

8. The method of claim 1, further comprising monitoring a position of a protected resource.

9. The method of claim 8, wherein monitoring the position of the protected resource further comprises tracking the protected resource via a communication device associated with the protected resource.

10. The method of claim 1, further comprising:
capturing an image of at least a portion of the object;
storing the image; and
associating the image with at least the present location of the mobile traffic monitoring system and a time that the image was captured.

11. A mobile traffic monitoring system, comprising:
a controller that defines a warning zone based, at least in part, on a present location of the mobile traffic monitoring system; and
an optical monitor that optically monitors the warning zone for movement of an object;
wherein, responsive to the optical monitor identifying the movement of the object in the warning zone, the controller generates a first alert.

12. The mobile traffic monitoring system of claim 11, further comprising:
a transceiver that communicates the first alert to a protected resource.

13. The mobile traffic monitoring system of claim 12, wherein:
communicating the first alert to the protected resource comprises communicating the first alert to a communication device associated with the protected resource.

14. The mobile traffic monitoring system of claim 11, further comprising:
a user interface that presents a proposed warning zone to a user;
wherein the proposed warning zone is modified in response to a user input to define the warning zone.

15. The mobile traffic monitoring system of claim 11, wherein:
while the warning zone is monitored, the controller determines the at least one movement parameter for the object, the at least one movement parameter selected from the group consisting of a speed and a velocity.

16. The mobile traffic monitoring system of claim 15, further comprising:
a transceiver or a network adapter that communicates a second alert to at least one entity selected from the group consisting of a protected resource and a server;
wherein:
the controller determines whether the object has a probability of colliding with a protected resource that is at least equal to a threshold value and, responsive to determining that the probability is at least equal to the threshold value, generates the second alert.

17. The mobile traffic monitoring system of claim 15, wherein:
the controller determines whether the object has collided with a protected resource and, responsive to determining that the object has collided with the protected resource, generates a second alert; and
the network adapter communicates the second alert to the server.

18. The mobile traffic monitoring system of claim 11, wherein the controller monitors a position of a protected resource.

19. The mobile traffic monitoring system of claim 18, wherein the controller tracks the protected resource via a communication device associated with the protected resource.

20. The mobile traffic monitoring system of claim 11, further comprising a data storage, wherein:
the optical monitor captures an image of at least a portion of the object;
the controller stores the image to the data storage; and
the controller associates the image with at least the present location of the mobile traffic monitoring system and a time that the image was captured.

21. A program storage device readable by a machine, tangibly embodying a program of instructions executable by the machine to perform method steps for monitoring traffic, said method steps comprising:
defining a warning zone based, at least in part, on a present location of the mobile traffic monitoring system;
with the mobile traffic monitoring system, optically monitoring the warning zone for movement of an object; and
responsive to identifying the movement of the object in the warning zone, generating a first alert.
